(19) United States
(12) Patent Application Publication
(10) Pub. No.: US 2019/0242849 A1
(43) Pub. Date: Aug. 8, 2019

(54) ELECTROPHORESIS DEVICE AND SYSTEM FOR MONITORING AND CONTROLLING THE SAME

(71) Applicant: Automated Laboratory Technologies IP Holding 1, LLC, Albany, NY (US)

(72) Inventor: Tony Hoang, Albany, NY (US)

(21) Appl. No.: 16/259,936

(22) Filed: Jan. 28, 2019

Related U.S. Application Data
(60) Provisional application No. 62/622,254, filed on Jan. 26, 2018.

(51) Int. Cl. G01N 27/447

(52) U.S. Cl. CPC G01N 27/44756; G01N 27/44747; G01N 27/44743; G01N 27/44713

(57) ABSTRACT

The present technology relates to an automatic monitoring system for cutting off a power supply to an electrophoresis device before a sample exits the gel. The monitoring system may include an image capture system for obtaining electromagnetic spectrum data associated with the movement of a sample through the gel. Additionally, the monitoring system may include a condensation prevention system to prevent or mitigate condensation that may forms on the image capturing system during the electrophoresis process. The monitoring system may further include a computer system in communication with the image capture system and with a power relay in order to facilitate cutting off the power to the electrophoresis device before a sample exits the gel. The computer system may be in further communication with an external communication device in order to stream, in real-time, the received electromagnetic spectrum data and with a storage system in order to store the data.

### CROSS REFERENCE TO RELATED APPLICATIONS

The present application claims priority under 35 U.S.C. § 119(e) to U.S. Provisional Application No. 62/622,254, filed 26 Jan. 2018, and entitled “ELECTROPHORESIS DEVICE AND SYSTEM FOR MONITORING AND CONTROLLING THE SAME,” which is incorporated by reference as if fully set forth herein.

### FIELD OF THE TECHNOLOGY

The present disclosure relates to electrophoresis systems, and more specifically, to an improved electrophoresis device and a system for monitoring and controlling an electrophoresis device.

### BACKGROUND

Electrophoresis is a method of moving charged particles in a solution or suspension by the application of an electric field to the solution or suspension. One common use of electrophoresis is in the realm of biotechnology for the separation and analysis of biomolecular samples such as DNA and proteins. For example, gel electrophoresis may be used to separate DNA fragments based on size and charge.

Conventional gel electrophoresis devices generally include a gel placed on a tray and submerged in a buffer solution within a casing or “box” structure. A power supply is attached to the box to apply an electric field through the electrodes across the gel to separate molecules of a sample within the gel. Further, samples typically mixed are with a die of some kind to make the sample visible to the human eye.

One challenge associated with conventional gel electrophoresis devices is the potential for samples to be under or over separated. For example, if current is applied to the gel for too short of a duration, the larger molecules may not have enough time to move and separate based on molecular weight. Alternatively, if current is applied to the gel for too long of a duration, the molecules will continue to move until they exit the gel. As a result, users of gel electrophoresis systems may be required to routinely monitor the process to determine the optimum time to turn off the power supply and prevent the molecules from exiting the gel. Accordingly, such a system unnecessarily requires a lot of man hours. Additionally, past attempts to automate this process have been based on invasive techniques (e.g., techniques requiring the addition of a foreign body to the gel/sample). For example, past attempts included a sensor within the gel that is able to detect the presence of the die. Such an invasive system is problematic in that it introduces the potential for corruption of a sample.

Another challenge associated with conventional gel electrophoresis devices is difficulty with viewing the progress of the sample within the gel. Due to the lack of transparency of the tray, box and gel, it can be hard for an observer to clearly see and track the progress of the sample within the gel. Attempts made to combat this feature, typically involve using a clear material such as glued together sheets of a transparent material, such as acrylic glass. While these attempts have resulted in clearer trays (and theoretically better visibility), the reflective properties of such materials tend to ultimately make it even more difficult to view the progress of the sample in the gel. Additionally, while such reflective properties can make it difficult for a human observer to view the sample, traditional systems utilizing camera technology to document the gel electrophoresis process have faced similar difficulties. Further, while attempts have been made to utilize tracking systems taking advantage of the clear nature of such boxes (e.g., systems incorporating a light source on one side of a sample and a light absorption sensor on the other side at a predetermined location), such systems ultimately face difficulty because the clear materials are, in addition to other problems involving visibility, prone to glare.

Yet another challenge associated with conventional gel electrophoresis devices is lack of structural stability. As discussed above, to achieve transparency of the box, conventional systems are comprised of glued together transparent materials. Such a manufacturing process results in hard 90-degree corners and/or edges of the boxes. As is understood, such a construction reduces the structural integrity of the device. Given that gel electrophoresis devices tend to be used in laboratory settings, structural integrity can be vital to maintaining safe working environments. Additionally, the presence of 90-degree internal corners and/or edges of the box may make it difficult to clean the device after use.

### SUMMARY

Aspects of the disclosed technology are directed to an improved electrophoresis device, or system, and to improved systems and methods for automatically monitoring and controlling an electrophoresis device.

Consistent with the disclosed embodiments, an improved electrophoresis device is disclosed. In an embodiment the gel electrophoresis device may include a box, a tray, a power supply, and at least two electrodes. The box may include one or more rounded corners, one or more ribbed exterior surfaces, and at least two openings in a surface of the box. The tray may be removably disposable within an inner portion of the box. The power supply may have an input wire and power conversion circuitry, and two output wires. The at least two electrodes may be removably attachable to the box and to the two power supply output wires and may be configured to provide an electrical path between power supply and the box.

Consistent with the disclosed embodiments, various methods and systems are disclosed. In an embodiment, a monitoring system for automatically monitoring and controlling an electrophoresis device is disclosed. The electrophoresis monitoring system may include box, a tray, a power supply, at least two electrodes, an image capture system, and a computer system. The box may include one or more rounded corners, one or more ribbed exterior surfaces, and at least two openings in a surface of the box. The tray may be removably disposable within an inner portion of the box. The power supply may have an input wire and power conversion circuitry, and two output wires. The at least two electrodes may be removably attachable to the box and to the two power supply output wires and may be configured to provide an electrical path between power supply and the box. The image capture system may be configured to capture image data associated with a sample contained in a gel deposited in the tray. The computer system may be configured to receive and analyze the image data and, responsive to determining that a gel electrophoresis process of the sample is complete, transmit an instruction to cause an interrupt in power supplied to the box.

Further features of the disclosed design, and the advantages offered thereby, are explained in greater detail hereinafter with reference to specific embodiments illustrated in the accompanying drawings, wherein like elements are indicated be like reference designators.

### BRIEF DESCRIPTION OF THE DRAWINGS

Reference will now be made to the accompanying drawings, which are not necessarily drawn to scale, and which are incorporated into and constitute a portion of this disclosure, illustrate various implementations and aspects of the disclosed technology and, together with the description, serve to explain the principles of the disclosed technology. In the drawings:

FIG. 1 shows a diagram of an electrophoresis monitoring system implemented on a horizontal gel electrophoresis device, according to an example embodiment of the disclosure.

FIG. 2 shows a diagram of an electrophoresis monitoring system implemented on a horizontal gel electrophoresis device, according to an example embodiment of the disclosure.

FIG. 3 shows a diagram of an electrophoresis monitoring system implemented on a vertical gel electrophoresis device, according to an example embodiment of the disclosure.

FIG. 4 shows an example of image data captured by an image capture system of an electrophoresis monitoring system, according to embodiments of the disclosure.

FIG. 5 shows an example of an image capture system of an electrophoresis monitoring system, according to embodiments of the disclosure.

FIGS. 6A-9 show an example housing for the monitoring system in the example of FIG. 2, according to embodiments of the disclosure.

FIG. 10A-11B shows examples of a gel electrophoresis box and tray, according to embodiments of the disclosure.

FIG. 12 shows an example a method for using the monitoring system of FIGS. 1-3, according to embodiments of the disclosure.

FIG. 13 shows an example of the computer system of the monitoring system of FIGS. 1-3, according to embodiments of the disclosure.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Embodiments of the present disclosure provide a monitoring system for cutting off a power supply to an electrophoresis device before a sample exits the gel. The monitoring system may include an image capturing system (e.g., camera) for obtaining electromagnetic spectrum data of the gel and sample therein, a relay connected to the power supply for the gel electrophoresis device, and a computer system in communication with the image capturing system and relay for indicating that the power supply should be cut off. Additionally, the monitoring system may include a condensation prevention system to prevent and/or mitigate condensation that may form on the image capturing system during the gel electrophoresis process. The gel electrophoresis monitoring system may allow for an automated gel electrophoresis process removing the requirement for a user to routinely monitor the progress of the sample within the gel. The monitoring system according to embodiments of the disclosure may further provide a wireless stream of real-time electromagnetic spectrum data of the progress of the sample within the gel to an external device such as a user's cell phone. Additionally, the gel electrophoresis system may also include a storage system for electromagnetic spectrum data collected by the image capture system.

Embodiments of the present disclosure may also provide a gel electrophoresis tray including an anti-reflective and/or colored surface to improve visibility of the progress of the sample within the gel. Embodiments of the present disclosure may further provide a gel electrophoresis box including at least one rounded and/or filleted edge and/or corner on the inside and/or outside of the box to improve the structural integrity of the box. The rounded and/or filleted corner and/or edge may also allow for ease of cleaning after a gel electrophoresis process has been run in the box.

Reference will now be made in detail to example embodiments of the disclosed technology, examples of which are illustrated in the accompanying drawings and disclosed herein. Wherever convenient, the same references numbers will be used throughout the drawings to refer to the same or like parts.

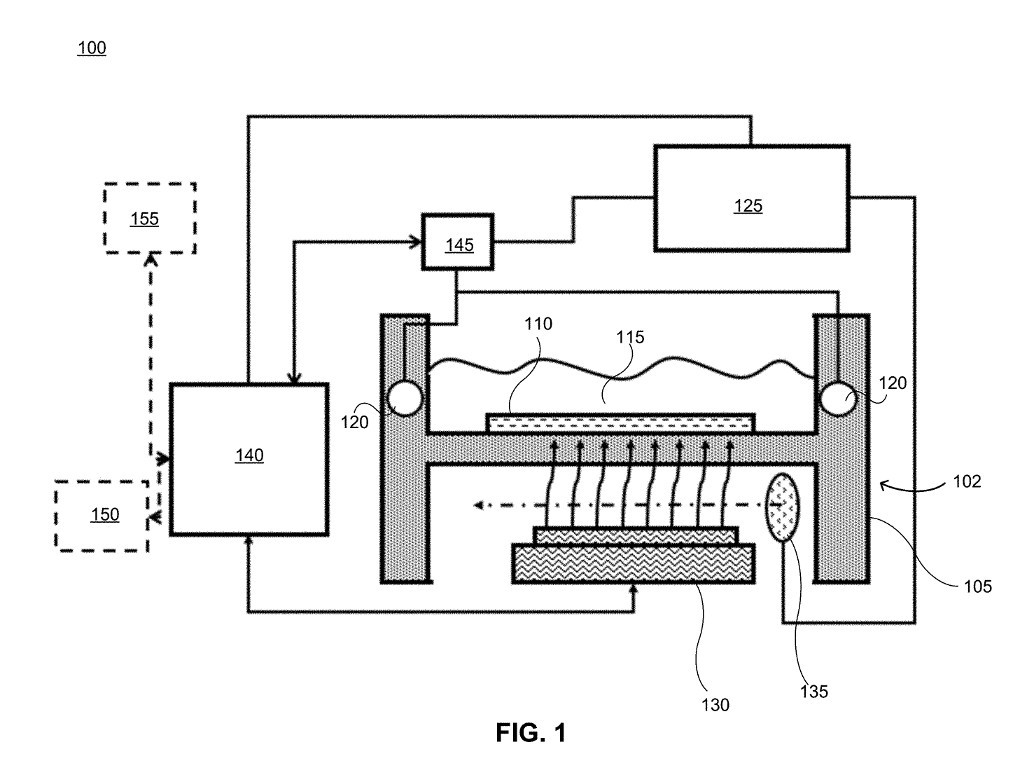

FIG. 1 is a diagram of an example electrophoresis monitoring system 100, according to embodiments of the disclosure. The components and arrangements shown in FIG. 1 are not intended to limit the disclosed embodiments as the components used to implement the disclosed processes and features may vary. In accordance with disclosed embodiments, electrophoresis monitoring system 100 may include an electrophoresis device 102, which may include a box 105 for holding a gel 110 within buffer fluid 115, one or more electrodes 120, and a power supply 125, an image capture system 130, a condensation prevention system 135, a computer system 140, a power relay 145, an external storage system 150, and an external communication system 155. As previously discussed, electrophoresis monitoring system 100 may be configured to monitor a gel electrophoresis process and cutoff power to a gel electrophoresis device upon completion of the process, e.g., before a sample runs of the gel.

As shown in FIG. 1, electrophoresis device 102 may include a box 105 for holding a gel 110 within buffer fluid 115, electrodes 120 for generating an electric field across gel 110, and a power supply 125 for providing power to electrodes 120. As depicted in FIG. 1, electrophoresis device 102 may be a horizontal electrophoresis device (e.g., the electrophoresis process occurs across a horizontal plane). In some embodiments of the present disclosure, electrophoresis device 102 may be a vertical electrophoresis device (e.g., the electrophoresis process occurs across a vertical plane). As will be understood, electrophoresis device 102 may include any now known or later developed electrophoresis device.

Also, as shown in FIG. 1, electrophoresis monitoring system 100 may include an image capture system 130 for obtaining real-time image data associated with the movement of a sample located within the gel 110 during the electrophoresis process. In some embodiments, the image data may be a real-time picture of the sample. In some embodiments, the sample may be mixed with a dye, and the image data may a picture of the dyed sample within the gel 100. In such an embodiment, the image data may be used by the computer system 140 to determine the location of the sample within the gel 110 as part of the tracking process. In some embodiments, the dyed sample may be viewable in the visible spectrum and image capture system 130 may capture visible spectrum data. According to some embodiments, the dyed sample may be viewable in the ultra violet spectrum and the image capture system 130 may capture ultraviolet spectrum data. In some embodiments, image capture system 130 may be positioned opposite or perpendicular to any readable surface of gel 110. For example, the readable surface of gel 110 may include any surface from which the movement of a sample within the gel 110 can be viewed and monitored. It should be understood that image capturing system 130 may be positioned at any desirable distance and/or angle from the readable surface of gel 110. In some embodiments, and as shown in FIG. 1, image capture system 130 may be positioned under box 105. In such an embodiment, for example, box 105 may include a transparent portion through which the image capture system 130 can obtain the real-time electromagnetic spectrum data associated with the movement of a sample located within the gel 110 during the electrophoresis process. In some embodiments, box 105 may contain an opening in the bottom through which the image capture system 130 may be inserted or affixed. As will be understood, the image capture system 130 may be arranged in a variety of locations relative the box 105 in order to adequately obtain the real-time electromagnetic spectrum data.

In some embodiments, image capture system 130 may be configured to continuously capture image data for a predetermined time period. According to some embodiments, image capture system 130 may be configured to continuously capture electromagnetic spectrum data until the gel electrophoresis process is complete. For example, image capture system 130 may be configured to continuously capture electromagnetic spectrum data until it is determined that the sample is nearing the edge of the gel 105. Image capturing system 130 may include a camera and/or any other now known or later developed device for capturing visible and/or ultraviolet spectrum data of an electrophoresis gel.

During the electrophoresis process, condensation may form on image capture system 130. In an example where image capture system 130 includes a camera, condensation may accumulate on the lens of the camera associated with the image capture system 130. To address this, and as further depicted in FIG. 1, electrophoresis monitoring system 100 may include a condensation prevention system 135 for preventing condensation from accumulating on image capture system 130. In some embodiments, and as depicted in FIG. 1, condensation prevention system 135 may include a fan providing airflow across and perpendicular to the surface of image capture system 130 facing gel 110. According to some embodiments, condensation prevention system 135 may include a hydrophobic coating on image capture system 130. For example, in an embodiment where the image capture system 130 includes a camera oriented towards the gel 110, the camera lens may include a hydrophobic coating. In a similar embodiment, the camera may also include at least one fan to dissipate heat away from the system 100.

As further depicted in FIG. 1, electrophoresis monitoring system 100 may include a computer system 140 for analyzing image data to determine whether the electrophoresis process is complete. For example, computer system 140 may be in electrical communication with image capture system 130 to receive real-time electromagnetic spectrum data captured by the image capture system 130. As previously discussed, computer system 140 may use software modules to analyze the images obtained from an image capture system 130 in order to track the dyed sample as it migrates through the electrophoresis gel 110. In some embodiments, and as depicted in FIG. 1, electrophoresis monitoring system 100 may further include a relay 145 in series between power supply 125 and electrodes 120 of gel electrophoresis device 102. Relay 145 may include any conventional relay capable of interrupting the power flow between the power supply 125 and electrodes 120. In some embodiments, computer system 130 may also be in electrical communication with relay 145 in order to cut off power to the gel electrophoresis device 102 upon completion of an electrophoresis process. For example, computer system 140 may receive real-time image data from image capture system 130 and may analyze the data. Upon determining that the electrophoresis process is complete, computer system 140 may transmit a signal to relay 145 to in turn cause relay 145 to interrupt the power flow between the power supply 125 and electrodes 120, thus removing the electric field across gel 110 and thereby ending the movement of the sample within gel 110. Computer system 140 may be electrically connected to relay 145, image capture system 130, and/or any other component of electrophoresis monitoring system 100 by physical wires and/or wireless communication devices. As described herein, a relay 145 has been described with reference to a traditional power relay wired in series between two points in an electrical system. As would be understood by one of skill in the art, a relay 145 may also include other devices capable of turning power on and off in response to a stimulus, such as, for example, a smart device such as a smart plug or smart outlet. For example, in an embodiment consistent with the disclosed technology, a computer system may communicate with a smart plug (e.g., relay 145) to turn off power to power supply 125 once the gel electrophoresis process is complete.

As shown in FIG. 1, electrophoresis monitoring system 100 may optionally include an external storage system 150 in communication with computer system 140. For example, computer system 140 may transmit the electromagnetic spectrum data obtained from image capture system 130 to storage system 150 for long term storage and additional analysis. External storage system 150 may include any conventional storage device such as, for example, an external hard drive. External storage system 150 may communicate with computer system 140 wirelessly or by physical connection, e.g., by USB cable.

Electrophoresis monitoring system 100 may also optionally include an external communication device 155 for communicating the status of the gel electrophoresis process to a user and/or allowing the user to remotely monitor the gel electrophoresis process. External communication device 155 may be in communication with computer system 140. For example, computer system 140 may transmit a real-time stream of electromagnetic spectrum data from image capture system 130 to external communication device 155 for display and analysis. In another example, computer system 140 may transmit a signal indicating the completion of the gel electrophoresis system to the external communication device 155. In yet another non-limiting example, external communication device 155 may be configured to allow a user to remotely control the electrophoresis process by sending signals to computer system 140. For example, a user may select an option on external communication device 155 to stop the electrophoresis process. In turn, the external communication device 155 may transmit a signal indicating the user's input to the computer system 140. The computer system 140 may then transmit a signal to relay 145 in order to cause relay 145 to interrupt the power flow between the power supply 125 and electrodes 120. In some embodiments, computer system 140 may wirelessly communicate with external communication device 155. In some embodiments, computer system 140 may communicate with external communication device 155 by physical a physical, or wired, connection (e.g., through a USB cable). External communication device 155 may include a cellular device, a laptop and/or any other now known or later developed external communication device. External communication device 155 may include an interface for displaying and entering data.

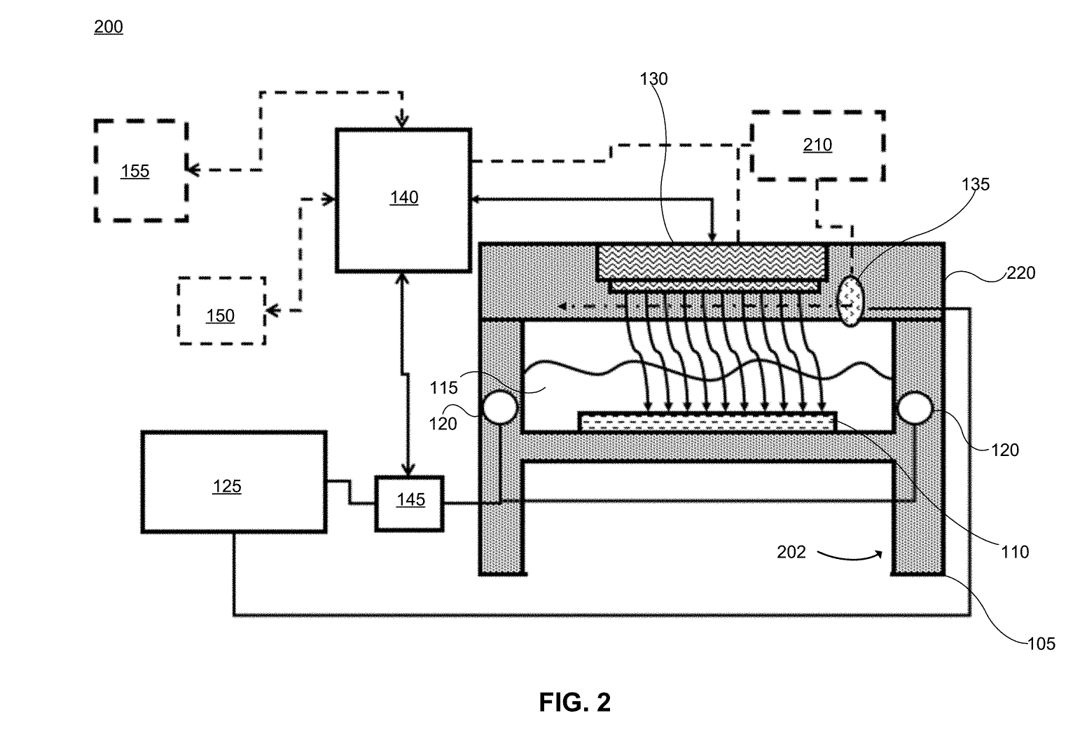

FIG. 2 is a diagram of an example electrophoresis monitoring system 200, according to embodiments of the disclosure. The components and arrangements shown in FIG. 2 are not intended to limit the disclosed embodiments as the components used to implement the disclosed processes and features may vary. In accordance with disclosed embodiments, electrophoresis monitoring system 200 may include an electrophoresis device 202, which may include a box 105 for holding a gel 110 within buffer fluid 115, a cover 220 for the electrophoresis device 102, one or more electrodes 120, and a power supply 125, an image capture system 130, a condensation prevention system 135, a computer system 140, a power relay 145, an external storage system 150, an external communication system 155, and a second power supply 210. Electrophoresis monitoring system 200, as shown in FIG. 2, differs from electrophoresis monitoring system 100 due to the positioning of the image capture system 130 relative to the electrophoresis device 102. As shown in FIG. 2, image capture system 130 may be positioned above box 105 inside the cover 220 for the electrophoresis device 102. In such an embodiment, for example, image capture system 130 may be positioned above gel 110.

As shown in FIG. 1, one or more components of electrophoresis monitoring system 100 requiring operating power may be connected to power supply 112. For example, as shown in FIG. 1, electrophoresis device 102, image capture system 130, condensation prevention system 135, and computer system 140 are all connector to a single power supply 125. Electrophoresis monitoring system 200, as shown in FIG. 2, differs in that it may include a second power supply 210. For example, as shown in FIG. 2, image capture system 130, computer system 140, and condensation prevention system 135 may be connected to second power supply 210. As will be understood, such a design presents the advantage of allowing the monitoring system 200 to have increased modularity. Second power supply 210 may include any now known or later developed source of power, e.g., a battery, outlet plug, etc.

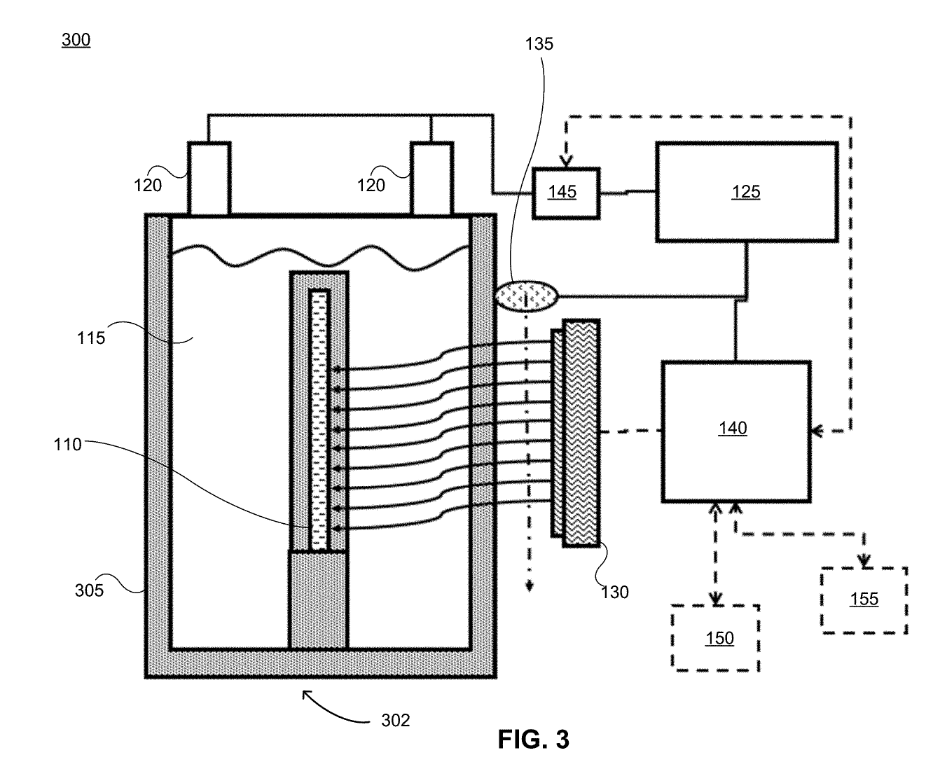

FIG. 3 is a diagram of an example electrophoresis monitoring system 300, according to embodiments of the disclosure. The components and arrangements shown in FIG. 3 are not intended to limit the disclosed embodiments as the components used to implement the disclosed processes and features may vary. In accordance with disclosed embodiments, electrophoresis monitoring system 300 may include an electrophoresis device 302, which may include a box 305 for holding a gel 110 within buffer fluid 115, one or more electrodes 120, and a power supply 125, an image capture system 130, a condensation prevention system 135, a computer system 140, a power relay 145, an external storage system 150, and an external communication system 155. Electrophoresis monitoring system 300, as shown in FIG. 3, differs from electrophoresis monitoring system 100 and electrophoresis monitoring system 200 due to the type of electrophoresis device 302 and due to the positioning of the image capture system 130 relative to the electrophoresis device 302. As shown in FIG. 3, electrophoresis device 302 includes a vertical gel electrophoresis device. In such an embodiment, image capture system 130 may be positioned along the sidewall of box 305 perpendicular to the readable surface of gel 110.

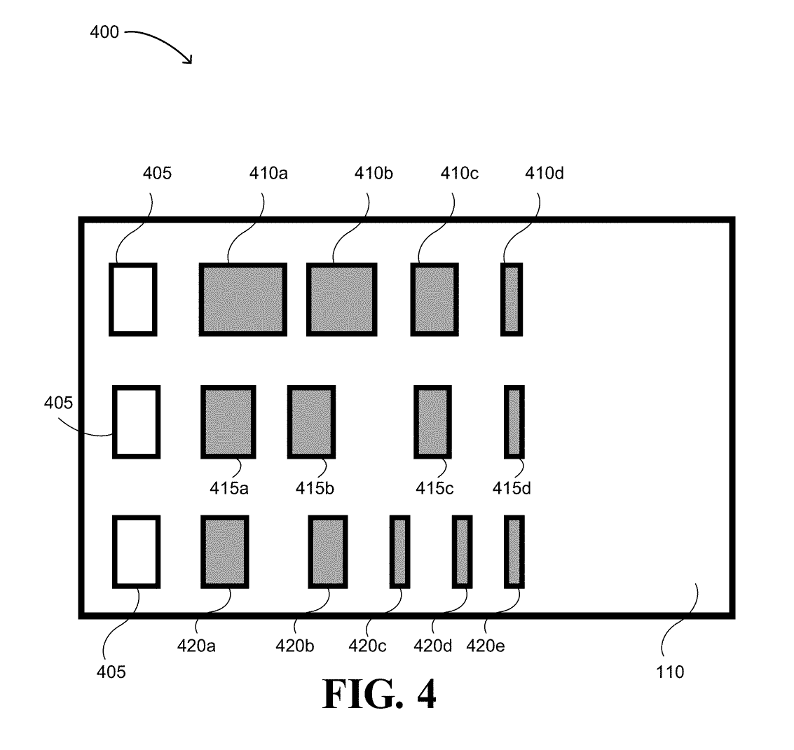

FIG. 4 provides an example of an image 400 representing visible spectrum captured by an image capturing system 130. As shown in FIG. 4, the captured image 400 depicts receiving wells 405 for receiving a sample 410, 415, 420. FIG. 4 further depicts sample 410a-d, sample 415a-d, and sample 420a-e moving from a respective receiving well 405 through the gel 110 during an electrophoresis process. As will be appreciated by one of skill, the different bands (e.g., 410a-410d) represent the separated portions of the sample after the electrophoresis process is completed.

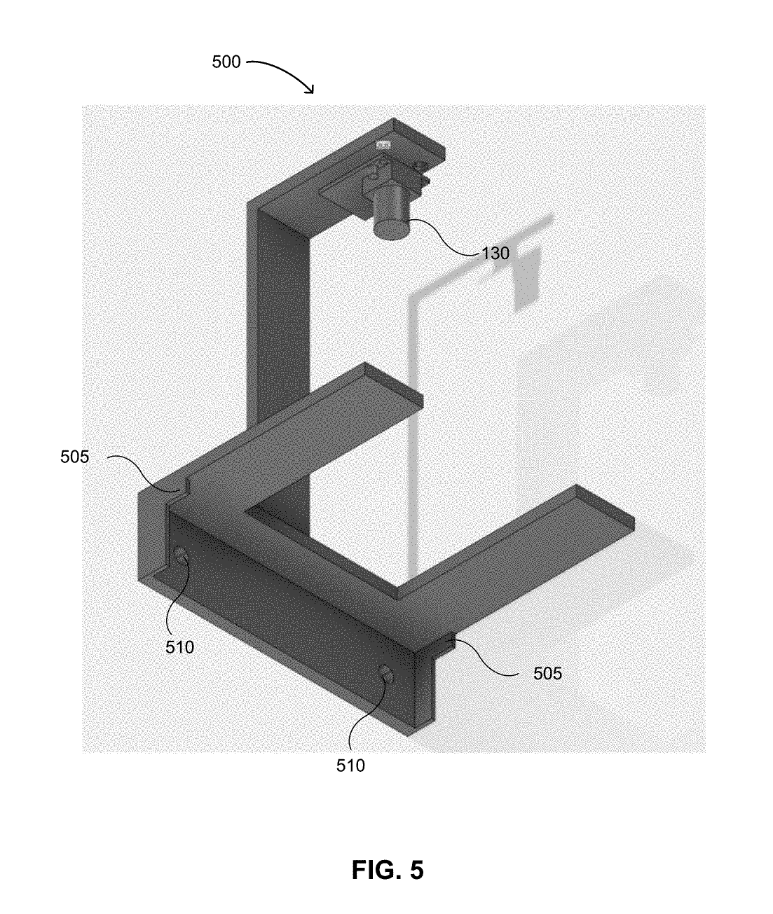

Turning next to FIGS. 5-10, which show examples of structures for attaching electrophoresis monitoring system 200 and/or components thereof to box 105 of electrophoresis device, according to embodiments of the disclosure. Although shown with respect to a horizontal gel electrophoresis device, it is understood that the attachment structures may be modified for vertical gel electrophoresis devices without exceeding the scope of the disclosure. Additionally, although shown to attach to electrophoresis monitoring system 200 above box 105, it is understood that the attachment structures may be modified for attaching the electrophoresis monitoring system 100 below box 105, without exceeding the scope of the disclosure.

FIG. 5 depicts an example of a mount 500 for attaching image capture system 130 to box 105 of gel electrophoresis device 102 of electrophoresis monitoring system 200, as shown in FIG. 2. Mount 500 may be formed by conventional manufacturing techniques. For example, mount 500 may be formed by three-dimensional printing, injection molding, casting, machining, etc. Mount 500 may be made from metal, plastic and/or any other desirable material for mounting an image capturing system to a gel electrophoresis box. In the non-limiting example of FIG. 5, image capture system 130 may include a conventional camera. In some embodiments, mount 500 may configured to hold image capture system 130 directly above gel 110 in box 105 of electrophoresis monitoring system 200 to capture an image 400 representing electromagnetic spectrum data of sample 410 in gel 110. According to some embodiments, mount 500 may be configured to attach to box 105 of electrophoresis monitoring system 200 in the same or similar manner as a conventional cover for a conventional gel electrophoresis device. For example, mount 500 may include edges 505 configured to engage the upper surfaces of box 105 of electrophoresis monitoring system 200. As also shown in FIG. 5, mount 500 may include openings 510 for receiving the leads of power supply 125 of electrophoresis monitoring system 200. According to some embodiments, mount 500 may receive the leads of power supply 125 of electrophoresis monitoring system 200 in order to connect to electrodes 120 located on box 105. In such an embodiment, openings 510 may line up with openings in any conventional gel electrophoresis box.

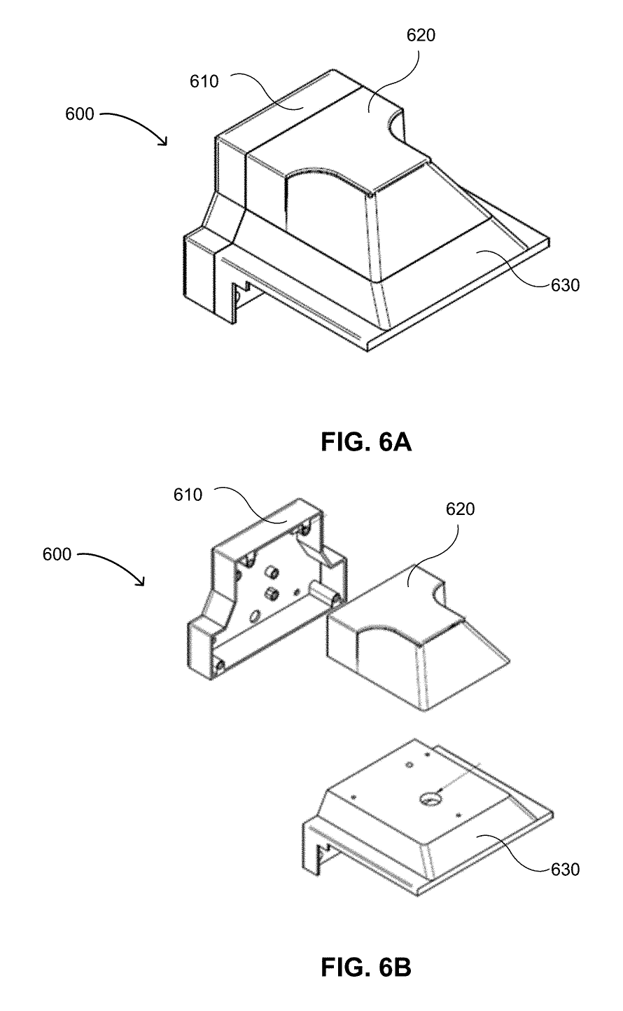

Referring next to FIGS. 6A9, an example of a housing 600 for the multiple components of an electrophoresis monitoring system is shown, according to embodiments of the disclosure. Housing 600 may be configured to hold image capture system 130, computer system 140, relay 145, and condensation prevention system 135 relative to box 105 of any now known or later developed gel electrophoresis device 102. FIG. 6A provides an isometric view of housing 600. As shown, housing 600 may include a back plate 610, a top cover plate 620, and a box cover plate 630. As shown in FIG. 6A, a rear surface of box cover plate 630 abuts back plate 610, and an upper surface of box cover plate 630 abuts top cover plate 620. FIG. 6B provides an exploded view of housing 600. Housing 600 and the components thereof may be formed by conventional manufacturing techniques. For example, housing 600 may be formed by three-dimensional printing, injection molding, casting, machining, etc. Housing 600 and the components thereof may be made from metal, plastic and/or any other desirable material for mounting an image capturing system to a gel electrophoresis box. Although shown in the example of FIG. 610 to be formed from the same material, it is understood that the components of housing 600 may be formed from different materials. As discussed above, the components of housing 600 may, for example, be removably attached to allow for access to the components of electrophoresis monitoring system 100, 200, or 300. Alternatively, the components of housing 600 may be permanently affixed to one another.

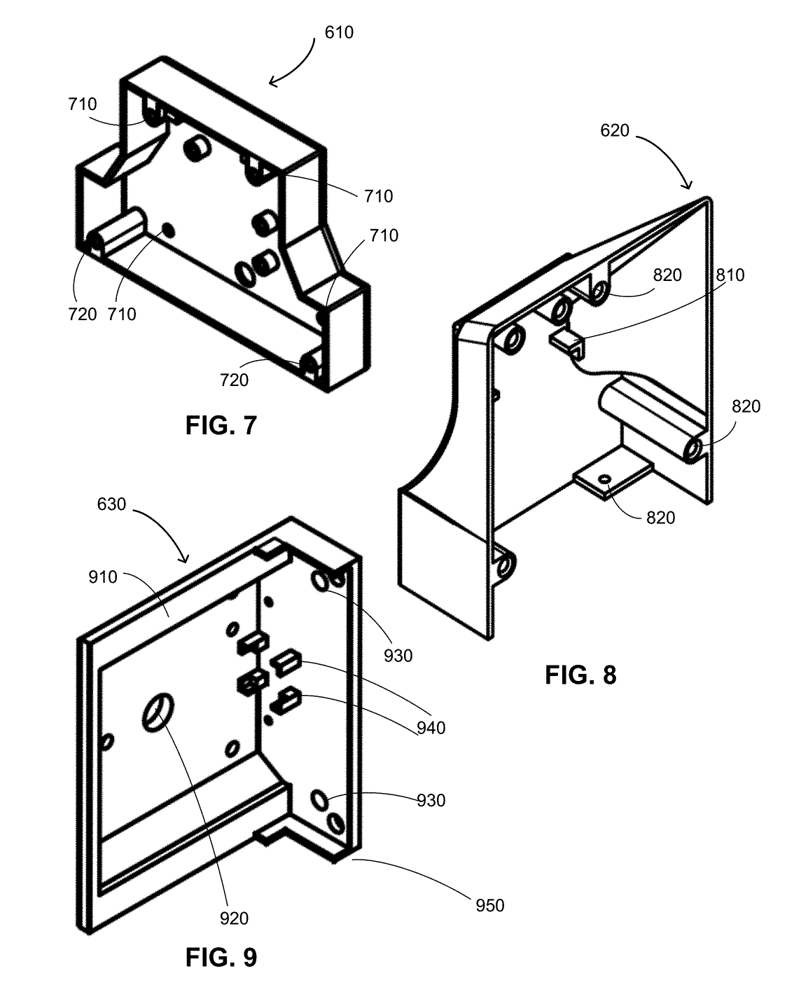

FIG. 7 shows an isometric view of back plate 610 of housing 600. As shown in FIGS. 6A and 6B, back plate 610 may attach to both top cover 620, and box cover plate 630. Back plate 610 may be attached to top cover 620 and box cover plate 630 by screws, adhesives, fasteners, snap in components, and/or any other mechanism for attaching components. In a non-limiting example, back plate 610 may be removably attached to top cover 620 and back cover plate 630 for ease of disassembly and access to components of electrophoresis monitoring system 100, 200, or 300. For example, back plate 610 may include openings 710 corresponding to openings in top cover 620 and box cover plate 630 for receiving screws for attachment. Further, as shown in FIG. 7, back plate 610 may include openings 720 corresponding to openings of box cover plate 620 for receiving the leads of power supply 125. According to some embodiments, back plate 610 may be hollow for holding wiring or other components (e.g., optional second power supply 210) of electrophoresis monitoring system 100, 200, or 300.

FIG. 8 shows an isometric view of top cover 620. As provided in FIGS. 6A and 6B, top cover 620 may sit on or be attached to the upper surface of box cover plate 610. In some embodiments, top cover 620 may be attached to box cover plate 610 by adhesive, fastener, snap in place structures and/or any other desirable method of affixing components together. For example, top cover 620 may be removably attached to box cover plate 610 to allow for access to components positioned within top cover 620. As shown in FIG. 8, top cover 620 may be hollow. As shown in FIG. 8, top cover 620 may include prongs 810, an adhesive (not shown), a fastener (not shown), or any other mechanism for holding image capture system 130 therein. Additionally, top cover 620 may include additional openings 820 for receiving wires and/or receiving screws for attachment to other components of housing 600. In some embodiments, top cover 620 may be configured to hold image capture system 130 of electrophoresis monitoring system 200 therein.

FIG. 9 shows an isometric view of box cover plate 630. As shown in FIG. 9, box cover plate 630 may be configured to engage the upper surfaces of box 105 of horizontal gel electrophoresis device 102. For example, box cover plate 630 may include edges 910 configured to engage the upper edges of any now known or later developed gel electrophoresis box 105. Edges 910 may, for example, sit on top of box 105 and engage the upper edges of the box in a similar manner as conventional gel electrophoresis box covers. In a non-limiting example, edges 910 may include the same or similar dimensions as conventional gel electrophoresis box covers. Box cover plate 630 may also include an opening 920 to allow for image capture system 130 to extend therethrough or above to capture electromagnetic spectrum data of gel 110 positioned within box 105 below box cover plate 630. In some embodiments, box cover plate 630 may include additional openings 930 for receiving the leads of power supply 125. Openings 930 may correspond to openings on conventional gel electrophoresis box 105 and be configured to allow for connection to electrodes 120.

Box cover plate 630 may also be configured to hold condensation prevention system 135 relative to image capture system 130. For example, in an embodiment where the condensation prevention system 135 comprises a fan, box cover plate 630 may be configured to hold fan such that the airflow from the fan prevents condensation from forming on the image capture system 130. For example, box cover plate 630 may include prongs 940, a fastener (not shown), an adhesive (not shown) and/or any other attachment mechanism for holding the fan (e.g., condensation prevention system 135) such that air flow created by the fan may pass along the surface of image capture system 130 facing gel 110. In some embodiments, box cover plate 630 may include a gap 950 which may allow for an opening (not shown) to be formed between the box cover plate 630 and the gel electrophoresis box 105 when attached to allow for external air to flow through the condensation prevention system 135 (e.g., fan) and across image capture device 130. According to some embodiments, edges 910 may also be configured to sit on box 105 such that there is an opening (not shown) between box 105 and box plate cover 630 opposite gap 950 to allow for the air flow to exit the system. Box cover plate 630 may also include opening 920 to allow for electrical leads for components of monitoring system 100 held thereto (e.g., condensation prevention system 135) to extend into the cavity of top cover 620 of housing 600 thereabove. Although now shown in FIG. 9, box cover plate 630 may be configured to house relay 145 to connect in series between the leads of power supply 125 extending through openings 930 and attaching to electrodes 120.

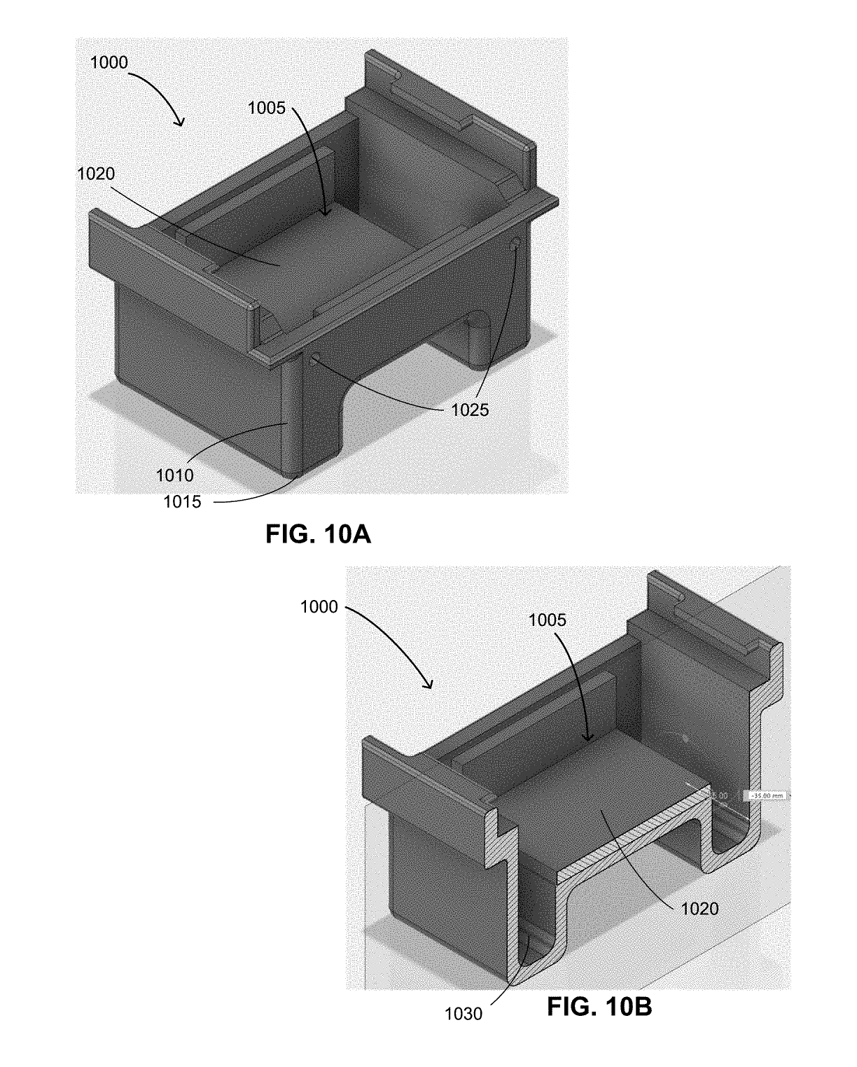

Turning to FIGS. 10A and 10B, an example of a gel electrophoresis box 1000 (referred to as “box” 1000 hereinafter) and tray 1005 is shown, according to embodiments of the disclosure. As shown in FIGS. 10A and 10B, box 1000 may be formed to include openings 1025 for either receiving electrical pads 120 or for receiving the leads of power supply 125 of electrophoresis monitoring system 200. Box 100 may further include least one and as many as all rounded edges (e.g., non 90-degree joints, as previously discussed). As will be appreciated, replacing traditional 90-degree joints with rounded and/or filleted corners and/or edges can improve the structural integrity of the box. For example, box 1000 may include an external rounded edge 1010 and/or corner 1015, and/or an internal rounded edge 1030 and/or corner (not shown). In some embodiments, box 1000 may alternatively be formed to include filleted edges and/or corners. Additionally, including at least one rounded and/or filleted edge and/or corner may allow for ease of cleaning of box 1000 after use. Box 1000 as described herein may be formed, for example, by injection molding, 3D printing and/or any other conventional manufacturing process. As will be appreciated, the use of such processes allow for filleted and/or rounded edges and/or corners to be formed in box 1000. Further, box 1000 may be formed from plastic, such as a high temperature plastic, and/or any other material compatible with manufacturing processes allowing for rounded and/or filleted corners and/or edges to be formed.

Additionally, as shown in FIGS. 10A and 10B, tray 1005 may be positioned within box 1000. According to embodiments of the disclosure, tray 1005 may be include at least one antireflective surface 1020. For example, tray 1005 may be formed from any now known or later developed antireflective material. In another example, tray 1005 may be coated with an antireflective material. In another non-limiting example, at least one surface (e.g., surface 1020) of tray 1005 may coated to be a predetermined color based on the die used in the gel electrophoresis process. For example, tray 1005 may include a color in contrast to the color of the die used. As a specific example, tray 1005 may be green, yellow, or blue where the die is pink, blue or yellow, respectively. Forming tray 1005 to have at least one antireflective surface and/or to be a predetermined color may allow for improved visibility of sample 410 in gel 110 during the gel electrophoresis process. Although FIGS. 10A and 10B depicts a tray 1005 for a horizontal gel electrophoresis device (e.g., device 102 from FIGS. 1 and 2), it is understood that any tray for any gel electrophoresis system (e.g., a vertical gel electrophoresis system as shown FIG. 3) may be formed according to embodiments of the disclosure. Tray 1005 including an antireflective surface and/or colored surface may be formed by any process and/or material compatible with the antireflective and/or colored material or coating.

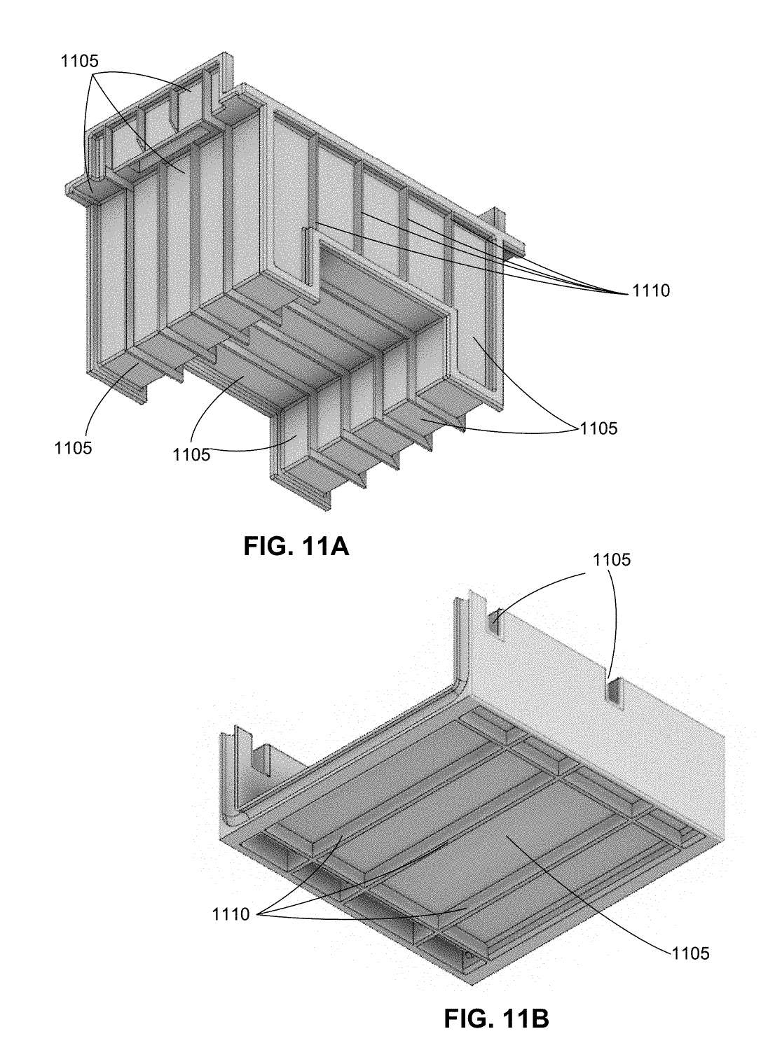

FIG. 11A depicts a box 1000, as in accordance with the previous description, further including one or more ribbed surfaces 1105. FIG. 11B depict a tray, 1005 as in accordance with the previous description, further including one or more ribbed surfaces 1105. Also, as shown in FIG. 11B, tray 1005 may include one or more comb receiving slots. As will be appreciated, a comb (not shown) may be included as part of gel electrophoresis device 102 to be used to create wells 405. As further shown, each of the one or more ribbed surfaces 1105 may include one or more ribs 1110. As will be appreciated by one of skill, the inclusion of at least one ribbed surface in the box design 1105 serves to increase the structural stability of box by distributing weight when a load is applied. Further, as will be appreciated, the inclusion of at least one ribbed surface 1105 in the box 1000 and/or tray 1005 design serves to improve the structural integrity of the box 1000 during manufacturer. As previously described, the box 1000 and tray 1005 may be injection molded, and the includes ion of at least one ribbed surface 1105 may prevent warping during manufacture.

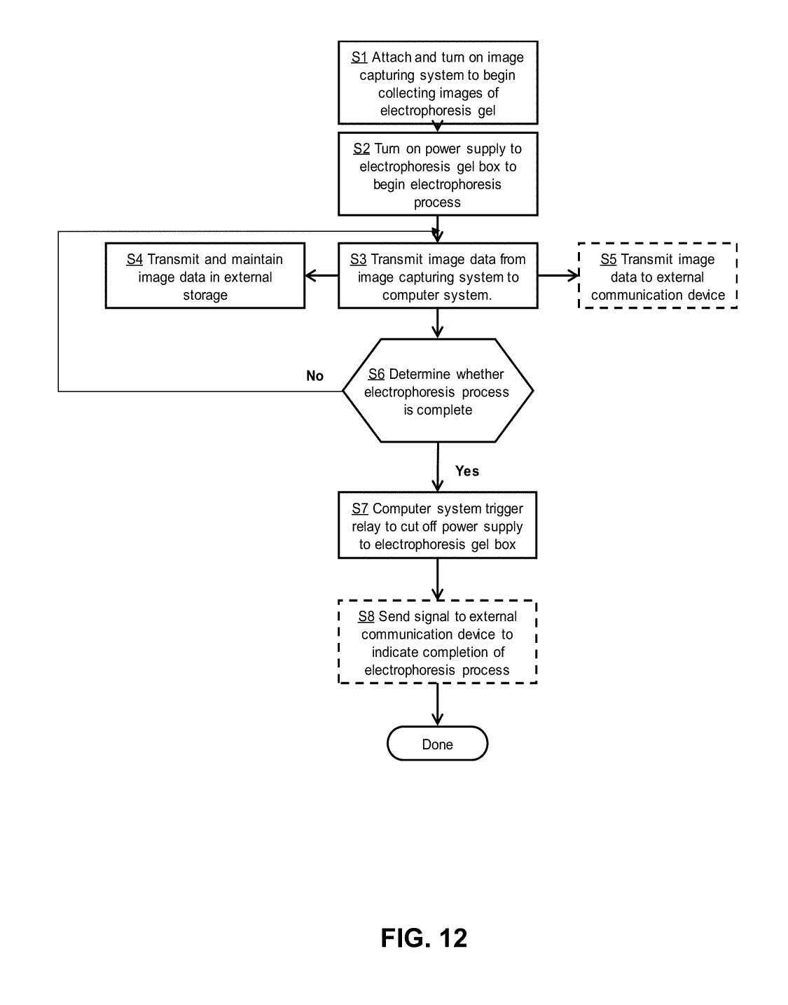

Turning next to FIG. 12, an example method 1200 of applying electrophoresis monitoring system 100 to a gel electrophoresis process is provided. Although shown in a particular order, it is understood that the steps of the method may be performed in any desirable order, or include additional steps, without exceeding the scope of the disclosure. As shown in FIG. 12, a first step (S1) of method 1200 may include attaching and turning on image capture system 130. Method 1200 may include a second step (S2) of turning on power supply 125, for example by connecting it to an outlet or battery. Method 1200 may include a third step (S3) of sending real-time electromagnetic spectrum data collected by image capture system 130 to computer system 140. Method 1200 may include optional fourth step (S4) of transmitting real-time electromagnetic spectrum data collected at computer system 140 to an external storage device 155. Method 1200 may include optional fifth step (S5) of transmitting real-time electromagnetic spectrum data collected at computer system 140 to an external communication device 150. Method 1200 may include sixth step (S5) of determining at computer system 140 whether the electrophoresis process is complete. When it is determined by the computer system 140 that the process is not complete, method 1200 may include looping back to S3. When it is determined by the computer system 140 that the process is complete, method 1200 may include seventh step (S7) of triggering, by the computer system 140, the relay 145 in order to cut off the power flowing from the power supply 125 to the electrodes 120. Finally, method 1200 may include optional eighth step (S8) of sending a signal to an external communication device 150 to indicate the completion of the electrophoresis process.

As described herein, methods and systems for monitoring and controlling the gel electrophoresis process may allow for users to remotely monitor the process without having to routinely check its progress. Methods and systems as described herein may allow for the collection and analysis of real-time data of the progress of a gel electrophoresis process. Additionally, among other things, the methods and systems described herein may mitigate the running off of samples in a gel due to excess duration of the gel electrophoresis process.

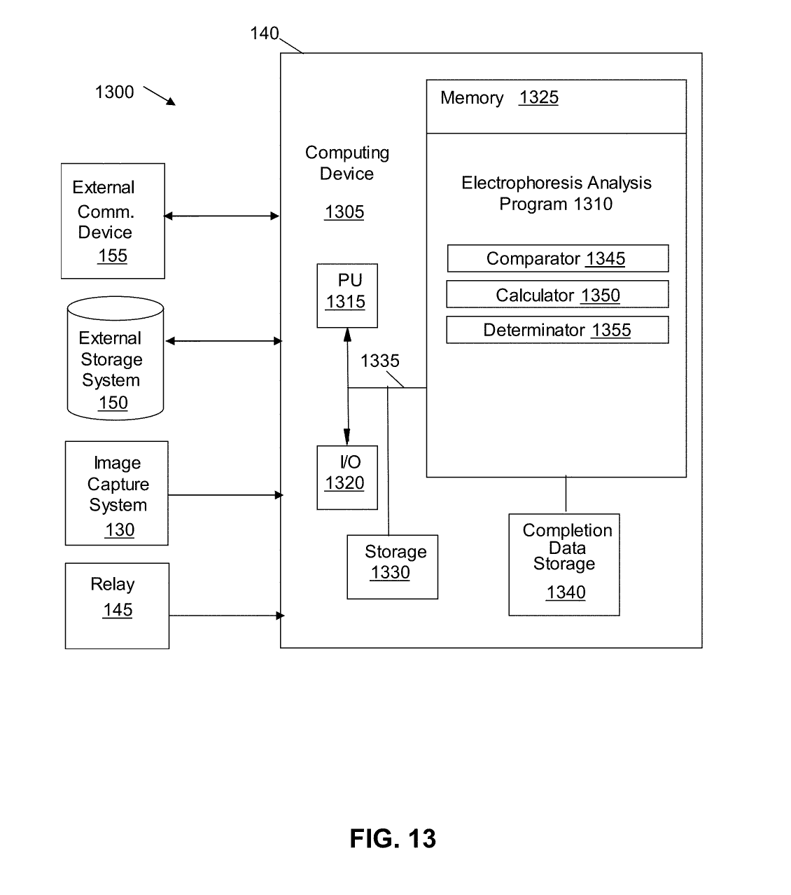

Turning to FIG. 13, an illustrative environment 1300 for implementing the methods and or systems described herein is shown. In particular computer system 140 of monitoring system 100 is shown as including a computing device 1305. Computing device 1305 can include electrophoresis analysis program 1310 which analyzes real-time electromagnetic spectrum data (e.g., image 400 of FIG. 4) of samples 410 within gel 110 to determine whether the electrophoresis process is complete, and communicates with relay 145 to turn off power flow from power supply 125 to electrodes 120 of gel electrophoresis device 102, according to embodiments described herein.

Computer system 140 is shown including a processing unit 1315 (e.g., one or more processors), an I/O component 1320, a memory 1325 (e.g., a storage hierarchy), a storage system 1330, a communications pathway 1335, and completion data storage 1340. As also shown in FIG. 13, computer system 140 may be in communication with external communication device 155 (e.g., laptop, cellular phone, etc.), external storage system 150 (e.g., external hard drive, computer memory, etc.), image capture system 130 (e.g., camera, etc.), and relay 145 of monitoring system 100. In general, processing unit 1315 can execute program code, such as electrophoresis analysis program 1310, which is at least partially fixed in memory 1325. While executing program code, processing unit 1315 can process data, which can result in reading and/or writing transformed data from/to memory 1325 and/or I/O device 1320 for further processing. Pathway 1335 provides a communications link between each of the components in environment 1300. I/O component 1320 can comprise one or more human 110 devices, which enable a human user to interact with computer system 140 and/or one or more communications devices to enable a system user to communicate with the computer system 140 using any type of communications link. To this extent, electrophoresis analysis program 1310 can manage a set of interfaces (e.g., graphical user interface(s), application program interface(s), etc.) that enable system users to interact with electrophoresis analysis program 1310. Further, electrophoresis analysis program 1310 can manage (e.g., store, retrieve, create, manipulate, organize, present, etc.) data, through several modules contained within memory 1325.

Memory 1325 can include various software modules configured to perform different actions, including a comparator 1345, a calculator 1350, and/or a determinator 1355. One or more of comparator 1345, calculator 1350, and/or determinator 1355 can use algorithm-based calculations, look up tables, software code, and/or similar tools stored in memory 1325 for processing, analyzing, and operating on data to perform their respective functions. Each module discussed herein can obtain and/or operate on data from exterior components, units, systems, etc., or from memory 1325 or completion data storage 1330 of computing device 140. Electrophoresis analysis program 1310 may, for example, obtain real-time electromagnetic spectrum data from image capture system 130 and gel electrophoresis completion data (e.g., example electromagnetic spectrum data of completed processes, marked electromagnetic spectrum data for comparison, or any other form of data for comparison with real-time electromagnetic spectrum data to determine whether the process is complete) from completion data storage 1330. In a non-limiting example, comparator 1345 may compare the real-time electromagnetic spectrum data and completion data; calculator 1350 may calculate differences between the real-time electromagnetic spectrum data and completion data; and determinator 1355 may determine whether the gel electrophoresis process is complete and therefore whether to instruct relay 145 to turn off power flow from power supply 125 to electrodes 120. In another non-limiting example, determinator 1355 may also determine whether to communicate with optional external communication device 155.

Where computer system 140 comprises multiple computing devices, each computing device may have only a portion of electrophoresis analysis program fixed thereon (e.g., one or more modules). However, it is understood that computer system 140 electrophoresis analysis program 1310 are only representative of various possible equivalent computer systems that may perform a process described herein. Computer system 140 can obtain or provide data, such as data stored in memory 1325 or storage system 1330, using any solution. For example, computer system 140 can generate and/or be used to generate data from one or more data stores, receive data from another system, send data to another system, etc.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A gel electrophoresis monitoring system comprising:
a box comprising:
one or more rounded corners;
one or more ribbed exterior surfaces; and
at least two openings in a surface of the box;
a tray removably disposable within an inner portion of the box;
a power supply having an input wire, power conversion circuitry, and two output wires;
at least two electrodes removably attachable to the box and to the two power supply output wires and configured to provide an electrical path between power supply and the box;
an image capture system configured to capture image data associated with a sample contained in a gel deposited in the tray; and
a computer system configured to receive and analyze the image data and, responsive to determining that a gel electrophoresis process of the sample is complete, transmit an instruction to cause an interrupt in power supplied to the box.

2. The gel electrophoresis monitoring system of claim 1 further comprising a relay configured to interrupt the electrical path between the power supply and the box.

3. The gel electrophoresis monitoring system of claim 3, wherein the relay comprises a smart electrical plug.

4. The gel electrophoresis monitoring system of claim 1 further comprising a precipitation prevention system configured to prevent condensation from accumulating on the image capture system.

5. The gel electrophoresis monitoring system of claim 1 further comprising a user device configured to communicate with the computer system.

6. The gel electrophoresis monitoring system of claim 1 further comprising an external storage device configured to store the image data.

7. The gel electrophoresis monitoring system of claim 6, wherein the tray comprises an antireflective material.

8. The gel electrophoresis monitoring system of claim 7, wherein the tray comprises a colored material.

9. The gel electrophoresis monitoring system of claim 1, wherein the computer system is configured to wirelessly communicate with the image capture system.

10. The gel electrophoresis monitoring system of claim 1, wherein each exterior surface of the box is a ribbed exterior surface.

11. The gel electrophoresis monitoring system of claim 1, wherein a bottom surface of the tray is a ribbed exterior surface.

12. A gel electrophoresis system comprising:
a box comprising:
one or more rounded corners;
one or more ribbed exterior surfaces; and
at least two openings in a surface of the box;
a tray removably disposable within an inner portion of the box;
a power supply having an input wire, power conversion circuitry, and two output wires; and
at least two electrodes removably attachable to the box and to the two power supply output wires and configured to provide an electrical path between power supply and the box.

13. The gel electrophoresis system of claim 12, wherein the box and tray are formed using injection molding.

14. The gel electrophoresis system of claim 12, wherein the tray comprises an antireflective material.

15. The gel electrophoresis system of claim 13, wherein the tray comprises a colored material.

16. The gel electrophoresis system of claim 12, wherein the box is formed from a plastic material.

17. The gel electrophoresis system of claim 12 further comprising a camera.

18. The gel electrophoresis system of claim 17 further comprising a cover, wherein the cover is configured to removably attach to a top surface of the box and the camera is removably disposable within an inner surface of the cover.

19. The gel electrophoresis system of claim 12, wherein each exterior surface of the box is a ribbed exterior surface comprising at least one rib.

20. The gel electrophoresis system of claim 12, wherein a bottom surface of the tray is a ribbed exterior surface.
